(19) United States
(12) Patent Application Publication
(10) Pub. No.: US 2005/0208674 A1
(43) Pub. Date: Sep. 22, 2005

(54) Method for analyzing impurities

(75) Inventors: Kaori Tokushima, Tokyo (JP); Yoshihiro Kawabata, Tokyo (JP)

Correspondence Address: PILLSBURY WINTHROP SHAW PITTMAN, LLP, P.O. BOX 10500, MCLEAN, VA, 22102, US

(73) Assignee: Sumitomo Mitsubishi Silicon Corporation, Tokyo (JP)

(21) Appl. No.: 11/080,469

(22) Filed: Mar. 16, 2005

(30) Foreign Application Priority Data
Mar. 19, 2004 (JP) P2004-081217

(51) Int. Cl. B08B 3/12

(52) U.S. Cl. 436/178; 134/2; 436/80

(57) ABSTRACT

The impurity analyzing method is for analyzing impurities that exist on a surface of a semiconductor wafer, which includes a step of bubbling a mixed solution including hydrofluoric acid and aqueous hydrogen peroxide or a mixed solution including hydrofluoric acid and aqueous ozone to generate a vapor including hydrofluoric acid and aqueous hydrogen peroxide or a vapor including hydrofluoric acid and aqueous ozone, a step of dissolving a film formed on the surface of the semiconductor wafer by means of the vapor including hydrofluoric acid and aqueous hydrogen peroxide or the vapor including hydrofluoric acid and aqueous ozone, a step of supplying liquid drops onto the surface of the semiconductor wafer and collecting the impurities along with the liquid drops, and a step of analyzing the collected impurities.

### BACKGROUND OF THE INVENTION

1. Field of the Invention

The present invention relates to a method for analyzing impurities and, more particularly, to a method for analyzing impurities that exist on the surface of silicon.

This application claims priority on Japanese Patent Application No. 2004-081217 filed on Mar. 19, 2004, the contents of which are incorporated herein by reference.

2. Background Art

Impurities existing on the surface of a semiconductor wafer can be roughly classified by the composition and form thereof into metallic impurities, organic matter, and particles. Among these, metallic impurities contained in silicon oxide film have significant influence on the electrical properties of a device formed on the semiconductor wafer, such as an increase in leakage current and a decrease in the insulation breakdown voltage of the oxide film.

Therefore, with the trend of the semiconductor manufacturing industry toward higher density of integration and smaller device size in the background, it is important to reduce the metallic impurities that cause significant deterioration in the electrical characteristics of the device. Thus, there is a need for a method to analyze impurities in order to monitor the contamination of semiconductor wafers.

In order to analyze impurities of a semiconductor wafer, it is common to collect the impurities deposited on the semiconductor wafer into a solution by vapor phase decomposition (VPD). The collecting liquid is then analyzed by atomic absorption spectroscopy (AAS) or inductively coupled plasma mass spectroscopy (ICP-MS).

For example, Japanese Patent Publication No. 2944099 discloses a method of measuring impurities. According to this method, a plurality of semiconductor wafers are held horizontally in a closed vessel. The vessel contains hydrofluoric acid solution at the bottom thereof. The hydrofluoric acid solution is left to stand for a predetermined period of time so as to evaporate, in order to dissolve the oxide film formed on the surface of the semiconductor wafer. Then a liquid is dripped onto the surface of the semiconductor wafer so that the liquid makes contact with the surface and the impurities are trapped in the liquid. The impurities held in the liquid are then analyzed.

However, with the method described in Japanese Patent Publication No. 2944099, hydrofluoric acid is left to stand for a predetermined period of time at normal temperature in a closed space where a plurality of semiconductor wafers are held with vertical spaces from each other so as to generate hydrofluoric acid vapor. With this setup, the amount of oxide film dissolved in the liquid varies depending on the temperature. Also, it is impossible to precisely control the amount of vapor generated and the dissolving rate.

Also because the hydrofluoric acid vapor tends to move upward, the oxide film on a semiconductor wafer located at a higher position is more likely to be dissolved in the closed space. As a result, there may occur such a problem that analysis is conducted without dissolving the impurities for some of the semiconductor wafers.

Also the method described in Japanese Patent Publication No. 2944099 uses a solution of hydrofluoric acid to dissolve the impurities. As a result, there is a problem that the impurities are not dissolved along with the silicon oxide film, and are again deposited on the semiconductor wafer.

### SUMMARY OF THE INVENTION

The present invention provides a method for analyzing impurities that exist on a surface of a semiconductor wafer by dissolving a film such as a native oxide film formed on the surface of the semiconductor wafer and impurities, and analyzing a solution that dissolves the impurities, particularly a method for analyzing the impurities such that the amount of the film formed on the surface of the semiconductor wafer that is dissolved in the solution is stabilized.

Another object of the present invention is to provide a method for analyzing impurities by dissolving the oxide film and impurities existing on the surface of a semiconductor wafer, dripping a liquid (collecting solution) onto the surface of the semiconductor wafer so as to easily collect the impurities by means of the liquid drops and improve the yield of collection of the impurities.

The present invention is a method for analyzing impurities that exist on a surface of a semiconductor wafer, which includes a step of bubbling a mixed solution including hydrofluoric acid and aqueous hydrogen peroxide or a mixed solution including hydrofluoric acid and aqueous ozone to generate a vapor including hydrofluoric acid and aqueous hydrogen peroxide or a vapor including hydrofluoric acid and aqueous ozone, a step of dissolving a film formed on the surface of the semiconductor wafer by means of the vapor including hydrofluoric acid and aqueous hydrogen peroxide or the vapor including hydrofluoric acid and aqueous ozone, a step of supplying liquid drops onto the surface of the semiconductor wafer and collecting the impurities along with the liquid drops, and a step of analyzing the collected impurities.

The semiconductor wafer may be a silicon wafer, a germanium wafer, a SiC wafer or the like. The film formed on the surface of the semiconductor wafer may be an oxide film such as a silicon oxide film or a nitride film. There is no limitation to the thickness of the film.

The impurities are metals such as Fe, Cr, Cu, Au, Pt or Ag.

Carrier gas used when bubbling the mixed solution may be an inert gas such as nitrogen gas or argon gas. There is no limitation to the flow rate of the carrier gas used in bubbling.

The mixed solution to be bubbled is the mixed solution including hydrofluoric acid and aqueous hydrogen peroxide or the mixed solution including hydrofluoric acid and aqueous ozone. The aqueous ozone is a solution in which ozone gas is dissolved.

The liquid drop may be formed from a mixed solution including hydrofluoric acid and aqueous hydrogen peroxide, a mixed solution including hydrochloric acid and aqueous hydrogen peroxide, or a mixed solution including hydrofluoric acid, hydrochloric acid, and aqueous hydrogen peroxide. Nitric acid may be used in place of aqueous hydrogen peroxide. By using these solutions in the form of drops, metals having lower levels of ionization tendency than that of Si, such as Cu, Ag, Au, or Pt can be collected.

According to the method for analyzing impurities of the present invention, first the semiconductor wafer is prepared. Then, the mixed solution including hydrofluoric acid and aqueous hydrogen peroxide or the mixed solution including hydrofluoric acid and aqueous ozone is prepared. The inert gas such as N₂ gas is introduced as the carrier gas into the mixed solution, thereby bubbling the mixed solution and generating vapor therefrom. The vapor is introduced into a closed vessel so as to react with the semiconductor wafer. The vapor that has been introduced includes hydrofluoric acid which dissolves the film formed on the surface of the semiconductor wafer. The vapor also includes aqueous hydrogen peroxide or aqueous ozone, which oxidizes metals existing on the surface of the semiconductor wafer and dissolves them. Thus, the film formed on the surface of the semiconductor wafer can be quickly dissolved at stable quantities. The rate of dissolving the film formed on the surface of a silicon wafer can be controlled by adjusting the flow rate of the carrier gas. In the process described above, the film formed on the surface of the semiconductor wafer is dissolved by the vapor, and the dissolving solution remains deposited on the surface of the semiconductor wafer.

Then liquid drops (collecting liquid) are supplied onto the surface of the semiconductor wafer. The liquid drops may be a mixed solution including hydrofluoric acid and aqueous hydrogen peroxide, a mixed solution including hydrochloric acid and aqueous hydrogen peroxide, or a mixed solution including hydrofluoric acid, hydrochloric acid, and aqueous hydrogen peroxide. Nitric acid may be used instead of aqueous hydrogen peroxide.

The liquid drop is moved to sweep over the entire surface of the semiconductor wafer. Thus, the dissolving solution deposited on the surface of the semiconductor wafer is taken into the liquid drop. The liquid drop dissolves the film formed on the surface of the semiconductor wafer such as silicon oxide film and impurities, and therefore can efficiently collect the impurities. The liquid drop which includes the dissolving solution of the film is then collected and analyzed, thereby to determine the kinds and amounts of impurities. Thus, degree of contamination of the semiconductor wafer by the impurities can be determined by analyzing the impurities collected.

The mixed solution used in generating the vapor by bubbling may include 5% by weight or more of hydrofluoric acid and 10% by weight or more of aqueous hydrogen peroxide, or include 5% by weight or more of hydrofluoric acid and 10% by weight or more of aqueous ozone.

Hydrofluoric acid has an action of dissolving the film formed on the surface of the silicon wafer. When the concentration of hydrofluoric acid is less than 5% by weight, the film formed on the silicon surface cannot be fully dissolved.

The aqueous hydrogen peroxide and the aqueous ozone have oxidizing action. When the concentration of the aqueous hydrogen peroxide is less than 10% by weight, metals in the silicon oxide film cannot be fully dissolved. Metallic impurities can be dissolved and oxidized by the oxidizing action. Particularly metals having lower levels of ionization tendency than that of Si can be dissolved.

In the step of dissolving the film formed on the surface of the semiconductor wafer, the semiconductor wafer may be kept at a predetermined low temperature in a closed vessel.

The low temperature at which the semiconductor wafer is kept is from 0 to 20° C. This makes it possible to condensate the vapor including hydrofluoric acid and aqueous hydrogen peroxide or the vapor including hydrofluoric acid and aqueous ozone and quickly dissolve the film formed on the silicon surface at a stable extent of dissolution. Therefore, in-plane unevenness in the silicon surface does not occur, and an amount of time to dissolve the film becomes constant for each semiconductor wafer.

When cooled to a temperature lower than 0° C., stable condensation cannot be achieved. When cooled to a temperature higher than 20° C., it is difficult to form condensations from the vapor. There is no limitation to the method of holding at a low temperature. For example, a cooling apparatus may be disposed below the semiconductor wafer that are held in horizontal position so as to cool the semiconductor wafer. In this case, the semiconductor wafer may be cooled either over the entire surface thereof or only in a part thereof.

The impurities may be at least one or more of Cu, Ag, Au, and Pt. These metals have lower levels of ionization tendency than that of Si. In the case in which hydrofluoric acid is used as the solution to generate vapor and pure water is used as the liquid drop (collecting liquid), the yield of metal collection becomes low. According to the present invention, however, even the metals described above can be collected with a high yield. Consequently, impurity concentration on the semiconductor wafer can be accurately measured.

### BRIEF DESCRIPTION OF THE DRAWINGS

FIG. 1 is a front view of an apparatus for analyzing impurities existing on a surface of a semiconductor wafer according to one embodiment of the present invention.

### PREFERRED EMBODIMENTS OF THE INVENTION

The present invention will now be described by way of preferred embodiments with reference to the accompanying FIGURE. It is to be understood, however, that the present invention is not limited to these embodiments.

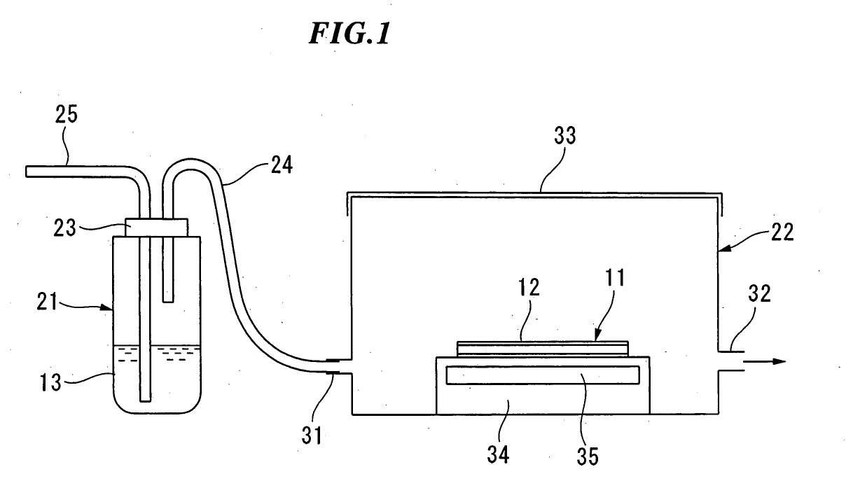

FIG. 1 shows an apparatus for dissolving a silicon oxide film 12 on a silicon wafer 11 according to one embodiment of the present invention. The apparatus has a dissolving solution container 21 and a box-shaped reaction vessel 22.

The dissolving solution container 21 is filled with 200 ml of a mixed solution 13 that dissolves the silicon oxide film 12. The mixed solution 13 contains 50% by weight of hydrofluoric acid and 35% of aqueous hydrogen peroxide. The dissolving solution container 21 is tightly closed with a lid 23 so that the mixed solution 13 does not evaporate and escape from the container 21.

The lid 23 has through holes through which a supply tube 24 and a bubbling tube 25 are inserted so that one end of each is located in the container 21. A carrier gas is blown into the mixed solution 13 in the container 25 so as to bubble the solution. Vapor of the mixed solution 13 generated by bubbling is introduced into the reaction vessel 22 through the supply tube 24.

The reaction vessel 22 has a lid 33 fitted at the top, and a stage 34 disposed in the reaction vessel 22. The stage 34 is a support member that supports the silicon wafer 11 (semiconductor wafer) horizontally. The stage 34 has a cooling unit 35 installed therein so as to cool the silicon wafer 11, that is supported on the stage 34, from below. The cooling unit 35 may be a cooling plate that utilizes a peltier element. An inlet port 31 is provided in a side wall of the reaction vessel 22. Connected to the inlet port 31 is the other end of the supply tube 24, so as to introduce the vapor of the mixed solution 13 into the reaction vessel 22. Provided in a side wall at a position opposite to the inlet port 31 is an exhaust port 32 for discharging the gas from the reaction vessel 22. Installed outside of the reaction vessel 22 is an exhaust pump not shown, with the pump and the exhaust port 32 being connected with a hose.

Now the method of analyzing the impurities existing on the silicon wafer 11 will be described in detail.

First, a silicon wafer (semiconductor wafer) 11 to be analyzed are prepared. The silicon wafer 11 has a silicon oxide film (native oxide film) 12 formed on a surface thereof. The silicon wafer 11 having the silicon oxide film 12 formed thereon are placed on the stage 34 in the reaction vessel 22, and the lid 33 is applied so as to tightly close the reaction vessel 22.

Then N₂ gas is introduced as the carrier gas through the bubbling tube 25 into the mixed solution 13 including hydrofluoric acid and aqueous hydrogen peroxide contained in the dissolving solution container 21. Flow rate of the carrier gas is 1 liter/min. This causes the mixed solution 13 to bubble, so that vapor of hydrofluoric acid and aqueous hydrogen peroxide is generated. The vapor is introduced through the supply tube 24 and the inlet port 31 into the reaction vessel 22. Thus, the inside of the reaction vessel 22 is filled with the vapor of hydrofluoric acid and aqueous hydrogen peroxide.

Meanwhile the silicon wafer 11 disposed on the stage 34 is cooled at 15° C. by the cooling unit 35. Thus, condensations are formed from the vapor that fills the reaction vessel 22 on the surface of the silicon wafer 11 that is cooled. Then the silicon wafer 11 disposed on the stage 34 in the reaction vessel 22 reacts with the vapor of the mixed solution. Specifically, the silicon oxide film 12 formed on the surface of the silicon wafer 11 is dissolved (decomposed) by the vapor. The dissolution follows the reaction described below.
SiO₂+4HF→SiF₄+2H₂O (a)

As indicated by the reaction scheme (a), SiF₄ gas is generated, which is discharged through the exhaust port 32 to the outside of the reaction vessel 22. Specifically, SiF₄ gas is discharged to the outside of the reaction vessel 22 by means of an exhaust pump not shown. Discharge pressure is 1000 Pa.

The metal contained in the impurity is dissolved through reaction with hydrogen peroxide. Dissolution of Cu, for example, follows the reaction described below.
Cu+2H₂O₂→CuO₂+2H₂O (b)

Copper is oxidized by hydrogen peroxide in the reaction scheme (b) and is dissolved.

Thus, the vapor of the mixed solution 13 can be generated simply by bubbling with N₂ gas, without heating the mixed solution 13 for dissolving, including hydrofluoric acid and aqueous hydrogen peroxide. A precise quantity of vapor can be supplied to the silicon wafer 11 by introducing the vapor into the reaction vessel 22 while discharging the gas. This enables it to quickly dissolve the silicon oxide film 12 on the surface of the silicon wafer 11 at a stable rate of dissolving. The rate of dissolving the silicon oxide film 12 can be controlled by means of the flow rate of the carrier gas.

The step of dissolving the silicon oxide film 12 with the vapor is carried out for 10 minutes (the duration of the process is set to 10 minutes). The silicon oxide film 12 is dissolved by the vapor and its dissolving solution covers the surface of the silicon wafer 11.

Then 100 μl of a liquid drop is dripped onto the surface of the silicon wafer 11 after dissolving. Pure water is commonly used for the liquid drop (collecting liquid). When pure water is used, heavy metals having higher levels of ionization tendency than that of Si, such as Fe, Cr, Ni, or Zn can be collected with a yield of 90%. Yield of collection for metals having lower levels of ionization tendency such as Cu, Ag, Au, or Pt becomes lower due to redeposition onto the silicon oxide film 12.

Therefore, a mixed solution including hydrofluoric acid and aqueous hydrogen peroxide is used for the liquid drop. Composition of the mixed solution contains 5% by weight of hydrofluoric acid and 5% by weight of aqueous hydrogen peroxide. The liquid drops may also be a mixed solution of hydrochloric acid and aqueous hydrogen peroxide, a mixed solution of hydrofluoric acid, hydrochloric acid, and aqueous hydrogen peroxide, or one of these mixed solutions including nitric acid instead of aqueous hydrogen peroxide.

The liquid drop is moved so as to sweep the surface of the silicon wafer 11, while tilting and rotating the silicon wafer 11 so that the liquid drop becomes attached to the entire surface. Thus, the dissolving solution of the silicon oxide film 12 is taken into the liquid drop. The liquid drop dissolves the impurities contained in the silicon oxide film 12. The liquid drop is then collected. Impurities that are collected are metals having lower levels of ionization tendency than that of Si, such as Cu, Ag, Au, and Pt.

The collecting liquid is then analyzed (quantitative analysis). Qualitative analysis or quantitative analysis by atomic absorption spectroscopy (AAS) may be employed for the analysis of the impurities. Thus, the impurities contained in the silicon oxide film 12 can be collected and analyzed, thereby to determine the degree of contamination of the silicon wafer.

Thus, the silicon oxide film formed on the surface of the silicon wafer can be quickly dissolved at stable quantities. The rate of dissolving the film can also be controlled. Yield of collecting the impurities is improved by dissolving metals along with the silicon oxide film.

Experiments were conducted while varying compositions of the dissolving liquid, compositions of the collecting liquid, and the processing time, in order to verify the yield of collecting the impurities by the method of the present invention by combining the different conditions.

The silicon wafer 11 having a diameter of 200 mm with the silicon oxide film 12 (native oxide film) formed on the surface thereof is prepared. The silicon oxide film 12 contains Cu with a concentration of 1×10¹⁰ atoms/cm². The following dissolving solutions were used to conduct the experiments, results of which are shown in Table 1.
(1) For the dissolving solution of an example, 200 ml of a mixed solution including 25% by weight of HF and 7% by weight of H₂O₂ was used. For the collecting liquid, 100 μl of a mixed solution including 5% by weight of HF and 5% by weight of H₂O₂ was used. Flow rate of the carrier gas (N₂ gas) was 1 liter/min. Discharge pressure was set to 1000 Pa. Duration of the process was set to 10 min.
(2) Same as (1) except for changing the concentration of H₂O₂ in the dissolving solution of (1) to 17.5% by weight.
(3) Same as (1) except for using 200 ml of a mixed solution including 15% by weight of HF and 25% by weight of H₂O₂ for the dissolving solution of (1).
(4) Same as (3) except for using 100 μl of a mixed solution including 5% by weight of HCl and 5% by weight of H₂O₂ for the collecting liquid of (3).
(5) Same as (3) except for using 100 μl of a mixed solution including 5% by weight of HF, 5% by weight of HCl and 5% by weight of H₂O₂ for the collecting liquid of (3).
(6) Same as (3) except for changing the processing time to 15 min.

The following conditions were employed for comparative examples.
(7) Same as (1) except for using 200 μl of a mixed solution including 5% by weight of HF and 32% by weight of H₂O₂ for the dissolving solution of (1) and setting the processing time to 30 min.
(8) Same as (6) except for using 200 μl of a mixed solution including 5% by weight of HF and 5% by weight of HNO₃ for the collecting liquid of (6).
(9) The dissolving solution of the comparative example is 200 ml mixed solution including 25% by weight of HF. The collecting liquid is 100 μl of a mixed solution including 5% by weight of HF and 5% by weight of H₂O₂. Flow rate of the carrier gas is 1 liter/min. Discharge pressure was set to 1000 Pa. Duration of the process was set to 10 min.

(10) Same as (9) except for using 100 μl of a mixed solution including 5% by weight of HF, 5% by weight of HCl and 5% by weight of H₂O₂ for the collecting liquid of (9).

TABLE 1

| | | Dissolving solution | Dissolving liquid | Processing | Yield of |
|---|---|---|---|---|---|
| | Condition | (Composition) | (Composition) | time (min) | collection |
| Examples | (1) | HF/H₂O₂ | HF/H₂O₂ | 10 | 34% |
| | | (25%/7%) | (5%/5%) | | (n = 1) |
| | (2) | HF/H₂O₂ | HF/H₂O₂ | 10 | 61% |
| | | (25%/17.5%) | (5%/5%) | | (n = 1) |
| | (3) | HF/H₂O₂ | HF/H₂O₂ | 10 | 72% |
| | | (15%/25%) | (5%/5%) | | (n = 2) |
| | (4) | HF/H₂O₂ | HCl/H₂O₂ | 10 | 77% |
| | | (15%/25%) | (5%/5%) | | (n = 1) |
| | (5) | HF/H₂O₂ | HF/HCl/H₂O₂ | 10 | 86% |
| | | (15%/25%) | (5%/5%/5%) | | (n = 1) |
| | (6) | HF/H₂O₂ | HF/H₂O₂ | 15 | 92.5% |
| | | (15%/25%) | (5%/5%) | | (n = 2) |
| | (7) | HF/H₂O₂ | HF/H₂O₂ | 30 | 88% |
| | | (5%/32%) | (5%/5%) | | (n = 1) |
| | (8) | HF/H₂O₂ | HF/HNO₃ | 15 | 83% |
| | | (15%/25%) | (5%/5%) | | (n = 2) |
| Comparative | (9) | HF | HF/H₂O₂ | 10 | 0% |
| Examples | | (25%) | (5%/5%) | | (n = 1) |
| | (10) | HF | HF/HCl/H₂O₂ | 10 | 0% |
| | | (25%) | (5%/5%/5%) | | (n = 1) |

The symbol n in Table 1 represents the number of sample wafers.

As a result, in the example, it was verified that yield of collecting Cu can be made higher than that of the comparative example by using the mixed solution including hydrofluoric acid and aqueous hydrogen peroxide as the dissolving solution. It was also verified that yield of collecting Cu can be improved to up to 92.5% by selecting the composition of the dissolving solution and the composition of the collecting liquid.

According to the present invention, first a semiconductor wafer is prepared. Then an inert gas such as N₂ gas is introduced as the carrier gas into a mixed solution including hydrofluoric acid and aqueous hydrogen peroxide or a mixed solution including hydrofluoric acid and aqueous ozone, thereby bubbling the mixed solution and generating vapor. The vapor is caused to react with the semiconductor wafer disposed in a closed vessel. Thus, a film formed on a surface of the semiconductor wafer can be quickly dissolved at stable quantities. The rate of dissolving the film such as silicon oxide film formed on the surface of the semiconductor wafer can be controlled by adjusting the flow rate of the carrier gas.

Since the mixed solution including hydrofluoric acid and aqueous hydrogen peroxide or the mixed solution including hydrofluoric acid and aqueous ozone is used, the film formed on the surface of the semiconductor wafer and metals contained in the film can be oxidized and dissolved. As a result, yield of collecting the impurities can be improved by collecting the dissolving solution of the film formed on the surface of the semiconductor wafer by means of the liquid drop.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description but is only limited by the scope of the appended claims.

1. A method for analyzing impurities that exist on a surface of a semiconductor wafer, the method comprising:
a step of bubbling a mixed solution including hydrofluoric acid and aqueous hydrogen peroxide or a mixed solution including hydrofluoric acid and aqueous ozone to generate a vapor including hydrofluoric acid and aqueous hydrogen peroxide or a vapor including hydrofluoric acid and aqueous ozone;
a step of dissolving a film formed on the surface of the semiconductor wafer by means of the vapor including hydrofluoric acid and aqueous hydrogen peroxide or the vapor including hydrofluoric acid and aqueous ozone;
a step of supplying liquid drops onto the surface of the semiconductor wafer and collecting the impurities along with the liquid drops; and
a step of analyzing the collected impurities.

2. The method for analyzing impurities according to claim 1,
wherein said mixed solution comprises 5% by weight or more of hydrofluoric acid and 10% by weight or more of aqueous hydrogen peroxide, or comprises 5% by weight or more of hydrofluoric acid and 10% by weight or more of aqueous ozone.

3. The method for analyzing impurities according to claim 1,
wherein the semiconductor wafer is cooled and held at a predetermined temperature in a closed vessel in the step of dissolving the film formed on the surface of the semiconductor wafer.

4. The method for analyzing impurities according to claim 1,
wherein the impurities are at least one or more of Cu, Ag, Au, and Pt.
